(19) United States
(12) Patent Application Publication
(10) Pub. No.: US 2025/0221884 A1
(43) Pub. Date: Jul. 10, 2025

(54) VIBRATING DEVICE

(71) Applicant: MysteryVibe Limited, Surrey (GB)

(72) Inventors: Robert Paul WEEKLY, Haslemere (GB); Soumyadip RAKSHIT, London (GB); Shanshan XU, London (GB); Hannah SACRANIE, Surrey (GB); David Ian HEYWOOD, Surrey (GB)

(73) Assignee: MysteryVibe Limited, Surrey (GB)

(21) Appl. No.: 18/853,558

(22) PCT Filed: Apr. 7, 2023
(86) PCT No.: PCT/IB2023/053593

§ 371 Date: Oct. 2, 2024

Related U.S. Application Data
(63) Continuation-in-part of application No. 29/853,929, filed on Sep. 20, 2022, now Pat. No. D047191.
(60) Provisional application No. 63/329,297, filed on Apr. 8, 2022.

(30) Foreign Application Priority Data
May 30, 2022 (GB) 6211356
May 31, 2022 (EM) 009048200-0005

(51) Int. Cl. A61H 19/00; A61H 7/00; A61H 23/02

(52) U.S. Cl. CPC A61H 19/00; A61H 7/001; A61H 23/0254; A61H 2201/0153; A61H 2201/1683; A61H 2201/5005; A61H 2201/5035; A61H 2201/5097; A61H 2205/087

(57) ABSTRACT

Vibrating devices or prostate stimulation devices according to various embodiments are provided. In some embodiments, the device includes a motor con-figured to generate vibration; an internal structure housing the motor; and a housing enclosing the internal structure. In some embodiments, the device includes a flexible neck having a first end and a second end; a base coupled to the first end of the flexible neck; and a tip coupled to the second end of the flexible neck. In some embodiments, the device includes a base with an input unit for receiving user input; a flexible neck having a first end coupled to the base; and a tip coupled to a second end of the flexible neck and comprising a motor configured to generate vibration. A shape of the device is changeable before or when the device is inserted into the rectum of a user to reach the prostate.

### CROSS-REFERENCE TO RELATED APPLICATIONS

This application includes a claim of priority under 35 U.S.C. § 119 (e) to U.S. provisional patent application No. 63/329,297, filed Apr. 8, 2022, and a claim of priority under 35 U.S.C. § 120 to U.S. design patent application Ser. No. 29/853,929, filed Sep. 20, 2022, claiming priority under 35 U.S.C. § 119 (a) and 172 to United Kingdom Design Application No. 6211356, filed May 30, 2022, and European Registered Community Design (RCD) application Ser. No. 00/904,8200-0005, filed May 31, 2022, the entirety of which is hereby incorporated by reference.

### FIELD OF INVENTION

The present invention relates to a vibrating device for massaging or stimulating the prostate.

### BACKGROUND

With an aging population worldwide, prostate-related ailments are becoming more and more commonplace. As men age, their prostate tends to grow. As the prostate grows, it can narrow the urethra, causing urinary symptoms of benign prostatic hyperplasia (BPH) such as frequent need to urinate, especially at night; difficulty starting urination; weak urine stream; dribbling at the end of urination; and inability to completely empty the bladder. In some cases, BPH can lead to incontinence (loss of bladder control), sexual dysfunction, prostatitis, bladder stones, cystitis (bladder infection), and reduced kidney function.

Therefore, prostate related issues form a big part of male sexual health issues. One of the most effective methods for keeping the prostate healthy is through regular massage. However, the prostate is hard to reach, especially by the user on their own, and the current solution is for a healthcare professional to insert his/her finger and massage that area. Studies have found that massaging the prostate several times a week can give relief from pain and pressure.

The prostate is both an accessory gland of the male reproductive system and a muscle-driven mechanical switch between urination and ejaculation. Prostate stimulation is undertaken to release excess seminal fluid—the fluid that mixes with sperm to create semen—from the ducts of the prostate gland. This can ease prostate inflammation while alleviating pressure on the urinary tract and potentially help with BPH causing enlargement of the prostate; prostatitis—inflammation of the prostate; urinary hesitancy—difficulty urinating; and erectile dysfunction.

Prostate massage is also used for sexual stimulation to help achieve arousal, enhance an erection, or relax the rectum in advance of anal sex. Referring to FIG. 3A, due to the proximity of the anterior wall of the rectum to the prostate in males, and the shared nerves thereof, rectal stimulation or penetration can result in sexual arousal. Thus, it is possible for some men to achieve orgasm solely through stimulation of the prostate gland, such as via prostate massage or anal intercourse.

Currently, the main way to undertake prostate stimulation is to visit a professional or urologist who then inserts his/her finger into the rectum to stimulate the prostate gland. This is an onerous and expensive activity and men often avoid it due to their inhibitions.

Therefore, there is a large unmet need to provide easier and inexpensive solution for prostate massage. Described herein is a device which offers an alternative solution for prostate massage/stimulation by delivering targeted vibration toward the prostate to stimulate and massage the prostate. The inventive device can be used easily, conveniently, and anytime whenever a user wants to massage/stimulate his prostate for medical and/or sexual purpose.

### SUMMARY OF THE INVENTION

The present disclosure provides a prostate stimulating device. According to various embodiments of the present invention, the prostate stimulating device includes a motor configured to generate vibration, an internal structure housing the motor, and a housing enclosing the internal structure. The shape of the prostate stimulating device is changeable.

In some embodiments, the housing made of a flexible material forms a surface of the device.

In some embodiments, the prostate stimulating device further includes a base in which electronics are housed, wherein the base is used as a handle held by a hand of a user.

In some embodiments, the prostate stimulating device further includes a flexible neck having a first end coupled to the base, the flexible neck allowing changing the shape of the device. The shape of the device is changeable before insertion into the rectum of the user such that the shape is retained unless meeting resistance beyond a threshold, and the device is configured to apply pressure and vibration to the prostate to a degree desired by the user according to the shape set by the user.

In some embodiments, the prostate stimulating device further includes a tip coupled to a second end of the flexible neck. In some embodiments, the motor is provided at the tip and the tip is configured to provide vibration to the prostate.

In some embodiments, the prostate stimulating device further includes an input unit provided at the base. The input unit is configured to receive user input for powering on/off the motor and/or controlling a vibration speed and/or a vibration pattern of the motor.

In some embodiments, the device is configured to provide various preset vibration patterns such that the user can select a desired one of the preset vibration patterns. In some embodiments, the preset vibration patterns programmable by the user.

In some embodiments, the device is controllable via an application running on a mobile device that is configured to communicate with the device wirelessly.

The present disclosure also provides a prostate massaging device. According to various embodiments of the present invention, the prostate massaging device includes a flexible neck having a first end and a second end, a base coupled to the first end of the flexible neck; and a tip coupled to the second end of the flexible neck. The shape of the prostate massaging device is changeable.

In some embodiments, the base is configured to be held by a user when the tip and the flexible neck are inserted into the rectum. The shape of the prostate massaging device is changeable before insertion into the rectum such that the shape is retained unless meeting resistance beyond a threshold.

In some embodiments, the tip includes a motor configured to generate vibration such that the vibration is applied to the prostate. The prostate massaging device is configured to apply pressure and vibration to the prostate to a degree desired by a user according to the shape of the device set by the user.

In some embodiments, the prostate massaging device further includes an input unit provided at the base. The input unit is configured to receive user input for powering on/off the motor and/or controlling a vibration speed and/or a vibration pattern of the motor.

In some embodiments, the base is wider than the tip, and the tip is wider than the flexible neck. In some embodiments, the flexible neck is longer than the base. In some embodiments, the flexible neck is longer than the tip.

The present disclosure also provides device including a base with an input unit for receiving user input, a flexible neck having a first end coupled to the base, and a tip coupled to a second end of the flexible neck and comprising a motor configured to generate vibration. The tip is configured to apply the vibration to the prostate when the device is inserted into the rectum of a user.

In some embodiments, the flexible neck is configured to change its shape while the device is being inserted into the rectum. In some embodiments, in response to the user input, the motor is turned on or off; a vibration speed of the motor is controlled; and/or a vibration pattern of the motor is controlled.

The present disclosure also provides a method of stimulating a prostate using a vibrating device. According to various embodiments of the present invention, the method includes bending a flexible neck of the vibrating device into a desired shape according to an amount of pressure a user desires against the prostate; inserting a tip of the vibrating device inside a rectum such that the flexible neck takes a shape of the rectum and moves up to reach the prostate; and causing the tip to deliver stimulation to the prostate by being vibrated by a vibration motor.

In some embodiments, the method further includes turning on the vibrating device and/or activating or setting a vibration pattern and/or intensity prior to or after inserting the tip to the rectum. In some embodiments, the method further includes changing a vibration intensity and/or pattern while the device is inside the rectum.

The present disclosure also provides a method of reducing prostate inflammation using a vibrating device. According to various embodiments of the present invention, the method includes bending a flexible neck of the vibrating device into a desired shape; inserting a tip of the vibrating device inside a rectum while a user holds a base of the vibrating device; moving up the vibrating device to reach a prostate such that the flexible neck takes a shape of the rectum; and causing a targeted vibration motor at the tip to deliver stimulation to the prostate.

### BRIEF DESCRIPTION OF THE FIGURES

Exemplary embodiments are illustrated in referenced figures. It is intended that the embodiments and figures disclosed herein are to be considered illustrative rather than restrictive.

FIG. 1 shows a front perspective view of a vibrating device in accordance with various embodiments of the present invention.

FIGS. 2A, 2B, and 2C show a deformable vibrating device in accordance with various embodiments of the present invention in various configurations.

FIG. 3A shows an example of prostate massage performed with a finger. (Prior Art)

FIG. 3B shows an exemplary use of a vibrating device in accordance with various embodiments of the present invention.

FIG. 4A is a front view of a vibrating device in accordance with various embodiments of the present invention.

FIG. 4B is a right side view of a vibrating device in accordance with various embodiments of the present invention.

FIG. 4C is a rear view of a vibrating device in accordance with various embodiments of the present invention.

FIG. 4D is a left side view of a vibrating device in accordance with various embodiments of the present invention.

FIG. 4E is a top view of a vibrating device in accordance with various embodiments of the present invention.

FIG. 4F is a bottom perspective view of a vibrating device in accordance with various embodiments of the present invention.

FIGS. 5A and 5B show how a vibrating device is held with a hand in accordance with various embodiments of the present invention.

### DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which this invention belongs.

The present invention is described with reference to the attached figures, wherein like reference numerals are used throughout the figures to designate similar or equivalent elements.

The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

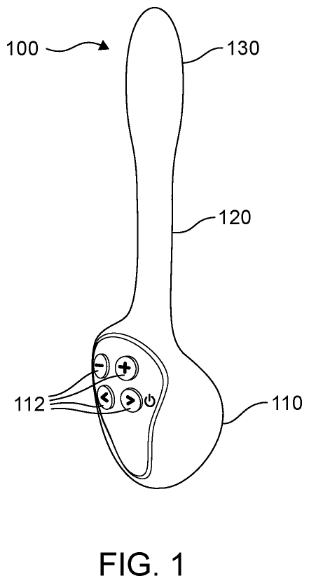

The various embodiments are directed to a vibrating device 100 that can be used as a prostate massaging device and/or a sexual stimulation device. The device 100 offers an alternative solution to finger massaging of the prostate generally performed by a health care professional. The device 100 can be self-administered by a user for prostate stimulation. Referring to FIG. 1, the vibrating device 100 is generally divided into three parts: i) a base 110, ii) a flexible neck 120, and iii) a tip 130. The slim bendable device 100 with the vibrating tip 130 is designed for targeted prostate stimulation when inserted into the rectum of the user.

According to various embodiments, the vibrating device 100 is waterproof or showerproof. According to various embodiments, a lubricant is applied to the vibrating device 100. After use, the device 100 can be fully submersed in water, making it very easy to clean with a toy cleaner or soap and water.

Referring to FIGS. 1-5B, the device 100 is designed to act like a human finger. The device 100 can be easily, comfortably, and stably held by a hand. The device 100 can be easily inserted into the rectum without causing pain, and deliver strong vibrations for effective prostate stimulation.

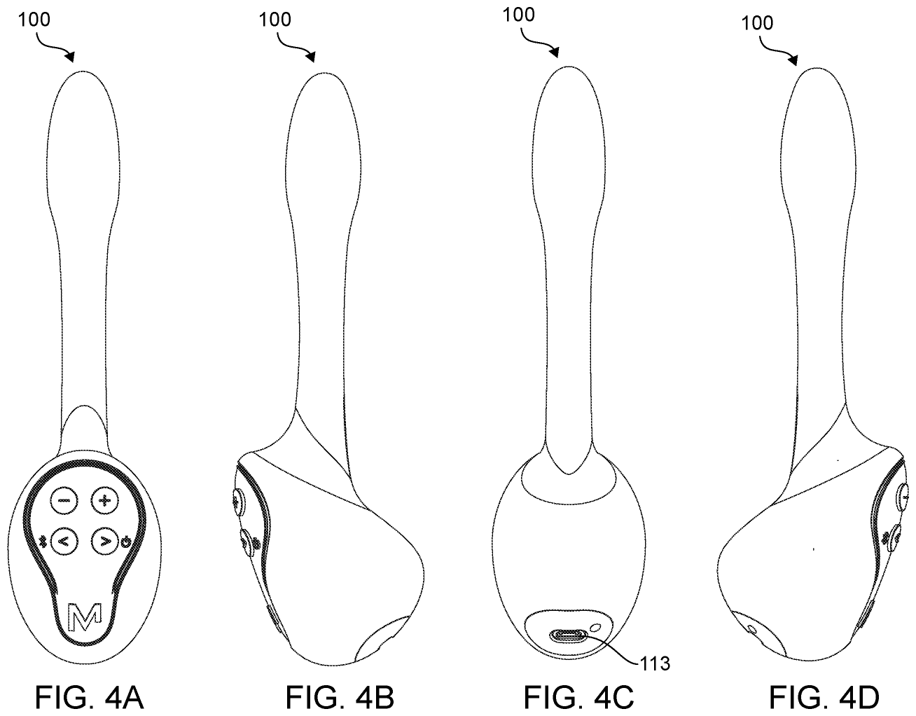

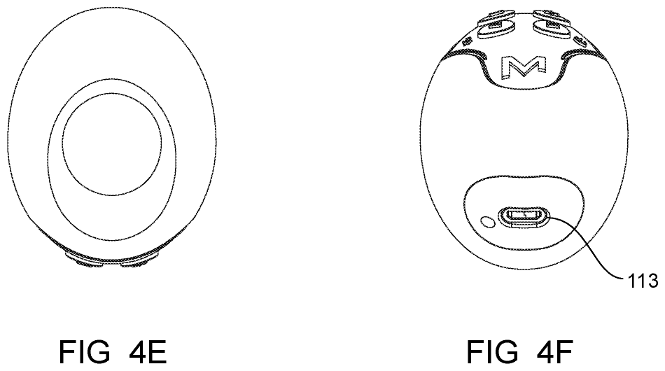

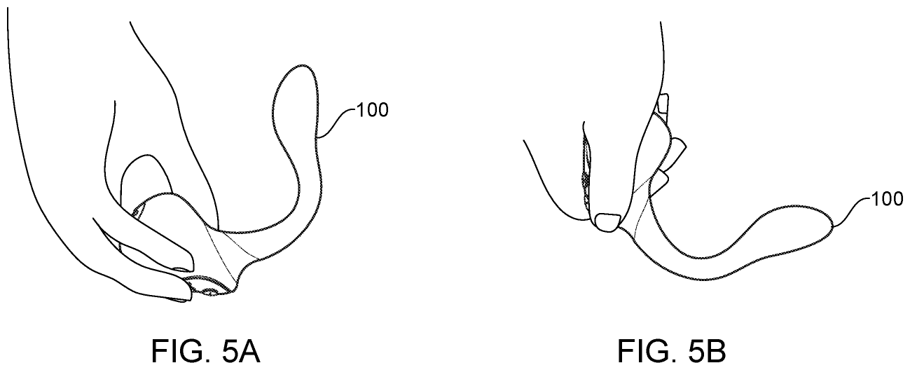

As exemplified in FIGS. 4B, 4D, 5A, and 5B, the base 110 of the device 100 is elongated such that the base 100 can be held by a hand. In some embodiments, the base 100 is made of a plastic material. In some embodiments, the base 100 does not have flexibility. In some embodiments, the base 110 is sized to fit in the hand. Referring to FIGS. 1, 2A-2C, and 4A-4D, in some embodiments, the base 110 is wider than the tip 130, and the tip is wider than the flexible neck 120. Thus, the base 110 doubles as a safety feature to prevent the entire device 100 being sucked up the rectum by accident. In some embodiments, the flexible neck 120 is longer than the base 110, and the flexible neck is longer than the tip 130. However, the width and length of the base 110, flexible neck 120, and the tip 130 are not limited thereto and may be changed based on the design of the device 100.

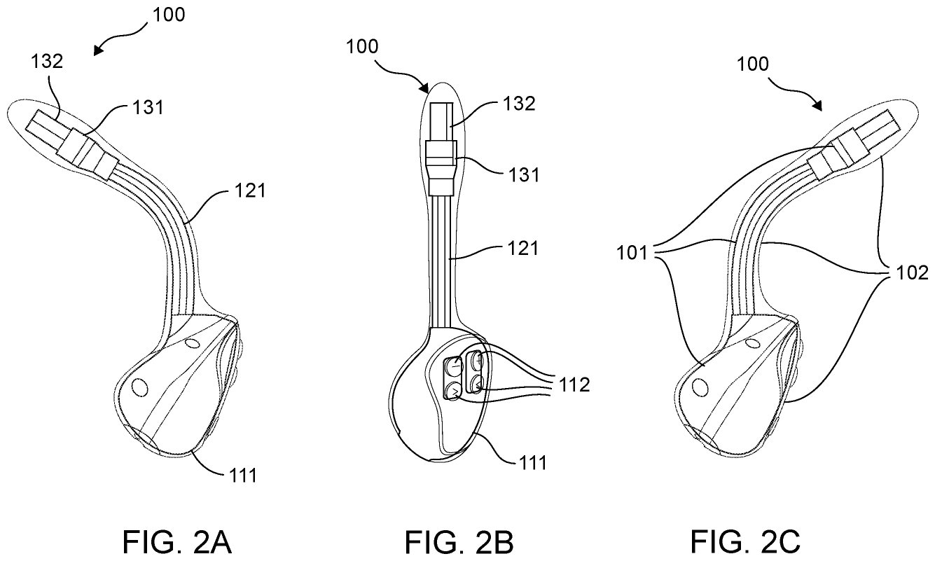

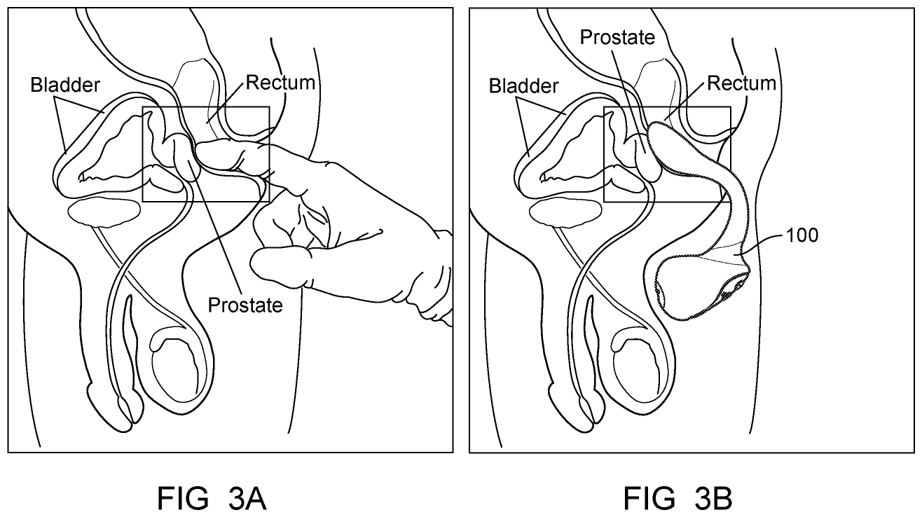

As exemplified in FIGS. 2A-2C, the device 100 is bendable due to the flexible neck 120 and can be configured to be in various shapes. The gooseneck-like flexible neck 120 is bendable in all directions, for example, side to side or front to back. Thus, the flexible neck 120 bends and takes the shape of the rectum as it is inserted. That is, the device 100 is designed to adapt to the anus, regardless of the size and shape. Further, the flexible neck 120 is rigid enough to retain its shape once inserted into the rectum while it is flexible enough to change its shape if it meets resistance above a threshold. Referring to FIG. 3B, the device 100 is bendable like a snake to go up the rectum and reach the prostate comfortably to deliver precise vibrations there. Although the neck 120 is flexible and bendable, in some embodiments, the base 110 and tip 130 are not flexible and do not bend.

In some embodiments, the device 100 is designed to be used comfortably during intercourse. The device's motor delivers strong vibrations to the prostate for heightened pleasure. The flexible neck 120 can hold its positions during the intercourse with a partner. The device 100 can be used not only as a prostate massager, but also as a stimulator to use on the penis or perineum, for anal pleasure for a partner, and more. Referring to FIGS. 2A-2C, the vibrating device 100 has an internal structure 101 having an inner base 111, an inner neck 121 having a first end coupled to the inner base, and a tip base 131 coupled to a second end of the inner neck. The tip 130 includes the tip base 131 and a vibration motor 132 coupled to the tip base for the internal structure 101. According to various embodiments, the device 100 includes a single power motor. However, the device 100 may include more than one power motors in some embodiments. The inner neck 121 is designed with a flexible neck utilizing a goose neck construction. This permits limited bending of the neck 120 to change to position of the vibrating tip 130. The internal structure 101 is encased in a housing or silicone sheath 102. In some embodiments, the housing 102 is made of a mixture of different materials. For example, a portion of the housing 102 covering the base 110 is made of a plastic material and a portion of the housing 102 covering the neck 120 and tip 130 is made of silicone.

According to some embodiments, the inner base 111 houses electronics and battery. In some embodiments, the battery is a rechargeable battery that powers the device 100. For example, the battery is a built-in lithium-ion battery. In some embodiments, the battery is within the base 110. In some embodiments, the battery is rechargeable via a port 113 of the device 100 and operably coupled to a circuit board and/or motor 132. In some embodiments, the battery is recharged wirelessly. For example, referring to FIGS. 4C and 4F, the port 113 is located at a portion of the base 110. In some embodiments, the port 113 is located at a bottom or side of the base 110. However, the location of the port 113 is not limited thereto, and the port may be located elsewhere on the device 100. For example, the port 113 is a Universal Serial Bus (USB) port including micro USB, USB-A, USB-B, and USB-C Port Types. The charged battery provides power to operate the motor 132.

In some embodiments, the vibrating device 100 further includes an input unit or switch 112. The vibrating device 100 has one, two, or multiple switches based on the design. For example, the vibrating device 100 is provided with four input buttons 112 on the surface of the base 110, as shown in FIG. 1. These input buttons 112 provide functions such as power on/off, vibration pattern navigation, intensity adjustment, and BLUETOOTH® connection. In some embodiments, two of the four input buttons 112 is for adjusting (increasing or decreasing) the intensity of vibration and the other two of the four input buttons 112 is for changing the vibration pattern. To turn on the device 100, a designated input button 112 is pressed and/or held for at least a threshold amount of time, i.e., 1 second, 2 seconds, or three seconds, for example. For example, at least two vibration patterns are programmed, and the currently set vibration pattern is changed to the next or previous vibration among the at least two vibration patterns by touching or pushing the corresponding input button 112. In some embodiments, pressing two input buttons 112 together causes the device 100 to cycle through different vibration patterns.

In some embodiments, the input buttons 112 provide functions such as BLUETOOTH® pairing. The vibrating device 100 has a wireless communication capability and is paired with a mobile device wirelessly, for example via BLUETOOTH®, to be controlled by the mobile device. For example, a mobile application or app, i.e., a computer program or software application, is run on the mobile device to control the vibrating device 100 via the mobile application. However, the device 100 works perfectly stand-alone without the app. The app allows the user to fully customize the vibrations, as well as being a remote control for the device 100.

In some embodiments, various vibration patterns generated by the motor 132 can be selected or set by a user. For example, a vibration pattern can comprise of set minutes (for example 1, 2, 3, 4, or 5 minutes) of unique pattern sequencing of the motor 132 before repeating. Vibration patterns are, for example, either pre-programmed on the circuit board of the vibrating device 100 or by using the user's mobile device or smart phone to remotely control the motor 132.

Users can create their own vibration patterns utilising the app available for the vibrating device 100. For example, the app is available on Google Play and Apple App stores. Once created, these vibration patterns can be loaded onto the vibrating device 100 for use in standalone operation mode.

Referring to FIGS. 3B, 5A, and 5B, in some embodiments, the vibrating device 100 is used in the following steps:
I) The user holds the wide base 110 of the device 100 in the hand and bends the neck 120 into a desired shape according to the amount of pressure the user desires against the prostate.
II) The user slowly inserts the slim tip 130 inside the rectum. The flexible neck 120 is rigid enough to retain its shape once inserted, but flexible enough to avoid discomfort if it meets resistance above a threshold.
III) The flexible neck 120 takes the shape of the rectum and easily moves up to reach the prostate.
IV) The targeted vibration motor 132 at the tip 130 delivers precise stimulation to the prostate.

In some embodiments, a lubricant is applied to the device 100. In some embodiments, the device 100 is turned on and the vibration intensity/pattern is set prior to being inserted to the anus. In some embodiments, the device 100 is turned on and/or the vibration intensity/pattern is set after being inserted to the anus. In some embodiments, the vibration intensity/pattern is changed while the device 100 is inside the rectum.

Further referring to FIG. 3B, in some embodiments, a method of prostate stimulation using the vibrating device 100 includes bending the flexible neck 120 into a desired shape and slowly inserting the slim tip 130 of the device inside the rectum while the user holds the wide base 110 of the device, moving up the device to reach the prostate such that the shape of the flexible neck 120 of the device is changed according to the shape of the rectum, and causing the targeted vibration motor 132 at the tip to deliver precise stimulation to the prostate. Here, the flexible neck 120 is rigid enough to retain its shape once inserted, but flexible enough to change its shape if it meets resistance above a threshold. Prostate stimulation according to this method is undertaken to release excess seminal fluid—the fluid that mixes with sperm to create semen—from the ducts of the prostate gland. Moreover, prostate stimulation can also be used for sexual stimulation to help achieve arousal, enhance an erection, and/or relax the rectum in advance of anal sex. In some embodiments, the slim tip 130 of the device 100 precisely reaches and stimulates not only the prostate gland or P-Spot, but also stimulates all over the anus and rectum, causing anal orgasms.

Further referring to FIG. 3B, in some embodiments, a method of reducing prostate inflammation using the vibrating device 100 includes bending the flexible neck 120 into a desired shape and slowly inserting the slim tip 130 of the device inside the rectum while the user holds the wide base 110 of the device, moving up the device to reach the prostate such that the flexible neck 120 of the device takes the shape of the rectum, and causing the targeted vibration motor 132 at the tip 130 to deliver precise stimulation to the prostate. Here, the flexible neck 120 is rigid enough to retain its shape once inserted, but flexible enough to change its shape if it meets resistance above a threshold. Reducing the prostate inflammation according to this method alleviates pressure on the urinary tract and potentially help with the following: benign prostatic hyperplasia (BPH)—enlargement of the prostate; prostatitis—inflammation of the prostate; urinary hesitancy—difficulty urinating; and erectile dysfunction.

Referring to FIGS. 4A-4F, the device 100 is ergonomically designed to be very compact and slim. This makes it perfect for users looking to explore prostate stimulation and anal orgasms. In various embodiments, the large base 110 with large buttons 112 makes it very accessible and easy to grip and use, even in the dark.

According to various embodiments of the present disclosure, a prostate stimulating device includes a motor configured to generate vibration; an internal structure housing the motor; and a housing enclosing the internal structure. A shape of the device is changeable. For example, the shape of the device can be changed before insertion into the rectum of a user, retaining its shape, unless meeting resistance beyond a threshold, such that pressure and vibration are applied to the prostate to a degree desired by the user. In some embodiments, the shape of the device can be changed when the device is inserted into the rectum of the user to reach the prostate.

According to some embodiments of the present disclosure, the housing made of a flexible material forms a surface of the device. In some embodiments, the device further includes a base in which electronics are housed. The base is used as a handle held by a hand of the user. In some embodiments, the device further includes a flexible neck having a first end coupled to the base, the flexible neck allowing changing the shape of the device. In some embodiments, the shape of the device is changeable before insertion into the rectum of the user such that the shape is retained unless meeting resistance beyond a threshold. In some embodiments, the device is configured to apply pressure and vibration to the prostate to a degree desired by the user according to the shape of the device set by the user. In some embodiments, the device further includes a tip coupled to a second end of the flexible neck. In some embodiments, the motor is provided at the tip and the tip is configured to provide vibration to the prostate. In some embodiments, the device further includes an input unit provided at the base. The input unit is configured to receive user input for powering on/off the motor and/or controlling a vibration speed and/or a vibration pattern of the motor. In some embodiments, the device is configured to provide various preset vibration patterns such that the user can select a desired one of the preset vibration patterns. In some embodiments, the preset vibration patterns programmable by the user. In some embodiments, the device is controllable via an application running on a mobile device that is configured to communicate with the device wirelessly.

According to various embodiments of the present disclosure, a prostate massaging device includes a flexible neck having a first end and a second end; a base coupled to the first end of the flexible neck; and a tip coupled to the second end of the flexible neck. A shape of the flexible neck is changeable.

According to some embodiments of the present disclosure, the base is configured to be held by a user when the tip and the flexible neck are inserted into the rectum. In some embodiments, the shape of the device is changeable before insertion into the rectum such that the shape is retained unless meeting resistance beyond a threshold. In some embodiments, the tip includes a motor configured to generate vibration such that the vibration is applied to the prostate. In some embodiments, the device is configured to apply pressure and vibration to the prostate to a degree desired by the user according to the shape of the device set by the user. In some embodiments, the device further includes an input unit provided at the base. The input unit is configured to receive user input for powering on/off the motor and/or controlling a vibration speed and/or a vibration pattern of the motor. In some embodiments, the base is wider than the tip, and the tip is wider than the flexible neck. In some embodiments, the flexible neck is longer than the base. In some embodiments, the flexible neck is longer than the tip.

According to various embodiments of the present disclosure, a device includes a base with an input unit for receiving user input; a flexible neck having a first end coupled to the base; and a tip coupled to a second end of the flexible neck and comprising a motor configured to generate vibration. The tip is configured to apply the vibration to the prostate when the device is inserted into the rectum of a user.

According to some embodiments of the present disclosure, the flexible neck is configured to change its shape while the device is being inserted into the rectum. For example, the flexible neck is rigid enough to retain its shape once inserted, but flexible enough to change its shape if it meets resistance above a threshold. In some embodiments, in response to the user input: the motor is turned on or off; a vibration speed of the motor is controlled; and/or a vibration pattern of the motor is controlled.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

1. A prostate stimulating device comprising:
a motor configured to generate vibration;
an internal structure housing the motor; and
a housing enclosing the internal structure,
wherein a shape of the device is changeable.

2. The prostate stimulating device according to claim 1, wherein the housing made of a flexible material forms a surface of the device.

3. The prostate stimulating device according to claim 1, further comprising a base in which electronics are housed, wherein the base is used as a handle held by a hand of a user.

4. The prostate stimulating device according to claim 3, further comprising a flexible neck having a first end coupled to the base, the flexible neck allowing changing the shape of the device, wherein the shape of the device is changeable before insertion into the rectum of the user such that the shape is retained unless meeting resistance beyond a threshold, and the device is configured to apply pressure and vibration to the prostate to a degree desired by the user according to the shape set by the user.

5. The prostate stimulating device according to claim 4, further comprising a tip coupled to a second end of the flexible neck.

6. The prostate stimulating device according to claim 5, wherein the motor is provided at the tip and the tip is configured to provide vibration to the prostate.

7. The prostate stimulating device according to claim 6, further comprising an input unit provided at the base, wherein the input unit is configured to receive user input for powering on/off the motor and/or controlling a vibration speed and/or a vibration pattern of the motor.

8. The prostate stimulating device according to claim 1, wherein the device is configured to provide various preset vibration patterns such that the user can select a desired one of the preset vibration patterns.

9. The prostate stimulating device according to claim 8, wherein the preset vibration patterns programmable by the user.

10. The prostate stimulating device according to claim 1, wherein the device is controllable via an application running on a mobile device that is configured to communicate with the device wirelessly.

11. A prostate massaging device comprising:
a flexible neck having a first end and a second end;
a base coupled to the first end of the flexible neck; and
a tip coupled to the second end of the flexible neck,
wherein a shape of the device is changeable.

12. The device according to claim 11, wherein the base is configured to be held by a user when the tip and the flexible neck are inserted into the rectum, and wherein the shape of the device is changeable before insertion into the rectum such that the shape is retained unless meeting resistance beyond a threshold.

13. The device according to claim 11, wherein the tip includes a motor configured to generate vibration such that the vibration is applied to the prostate, and wherein the device is configured to apply pressure and vibration to the prostate to a degree desired by a user according to the shape of the device set by the user.

14. The device according to claim 13, further comprising an input unit provided at the base, wherein the input unit is configured to receive user input for powering on/off the motor and/or controlling a vibration speed and/or a vibration pattern of the motor.

15. The device according to claim 11, wherein the base is wider than the tip, and the tip is wider than the flexible neck.

16. The device according to claim 15, wherein the flexible neck is longer than the base.

17. The device according to claim 16, wherein the flexible neck is longer than the tip.

18. A device comprising:
a base with an input unit for receiving user input;
a flexible neck having a first end coupled to the base; and
a tip coupled to a second end of the flexible neck and comprising a motor configured to generate vibration,
wherein the tip is configured to apply the vibration to the prostate when the device is inserted into the rectum of a user.

19. The device according to claim 18, wherein the flexible neck is configured to change its shape while the device is being inserted into the rectum.

20. The device according to claim 18, wherein, in response to the user input:
the motor is turned on or off;
a vibration speed of the motor is controlled; and/or
a vibration pattern of the motor is controlled.

21. A method of stimulating a prostate using the device of claim 11, the method comprising:
bending the flexible neck into a desired shape according to an amount of pressure a user desires against the prostate;
inserting the tip inside a rectum such that the flexible neck takes a shape of the rectum and moves up to reach the prostate; and
causing the tip to deliver stimulation to the prostate by being vibrated by a vibration motor.

22. The method of claim 21, further comprising turning on the device and/or activating or setting a vibration pattern and/or intensity prior to or after inserting the tip to the rectum.

23. The method of claim 21, further comprising changing a vibration intensity and/or pattern while the device is inside the rectum.

24. A method of reducing prostate inflammation using the device of claim 11, the method comprising:
bending the flexible neck into a desired shape;
inserting the tip inside a rectum while a user holds the base;
moving up the device to reach a prostate such that the flexible neck takes a shape of the rectum; and
causing a targeted vibration motor at the tip to deliver stimulation to the prostate.
